(19) United States
(12) Patent Application Publication
(10) Pub. No.: US 2014/0040833 A1
(43) Pub. Date: Feb. 6, 2014

(54) EDGE-AWARE POINTER

(71) Applicant: Patrick Martin McLean, Seattle, WA (US)

(72) Inventor: Patrick Martin McLean, Seattle, WA (US)

(73) Assignee: Adobe Systems Incorporated, San Jose, CA (US)

(21) Appl. No.: 13/409,894

(22) Filed: Mar. 1, 2012

(51) Int. Cl. G06F 3/048

(52) U.S. Cl. 715/856

(57) ABSTRACT

A machine with a display screen may provide a user interface with an edge-aware pointer (e.g., an edge-aware cursor). This pointer may be edge-aware in the sense that the machine may reorient the pointer based on the pointer being moved (e.g., according to input received from a user) near one or more edges of the display screen. The machine may provide a pointer in the form of an offset pointer that is automatically rotated to a new orientation based on the pointer being moved within a threshold distance from the edge of the display screen. Hence, the pointer may enable a user to precisely position the pointer and precisely indicate any location on the display screen, regardless of proximity to any edge of the display screen.

### TECHNICAL FIELD

The subject matter disclosed herein generally relates to the processing of data. Specifically, the present disclosure addresses systems and methods of providing an edge-aware pointer.

### BACKGROUND

Modern user interfaces (e.g., graphical user interfaces) for machines (e.g., computers, phones, or devices) with a display screen (e.g., a touch screen, a monitor, a flat panel display, or any suitable combination thereof) are configured to present a movable pointer (e.g., a cursor). Such a pointer may be operable to indicate a location on the display screen (e.g., the location of a single pixel among an array of pixels being displayed on the display screen). Accordingly, a user interface may allow a user to move the pointer around the display screen and thereby indicate one or more various locations on the display screen.

### BRIEF DESCRIPTION OF THE DRAWINGS

Some embodiments are illustrated by way of example and not limitation in the figures of the accompanying drawings.

FIG. 1-2 are face views of a display screen, illustrating movement and reorientation of an edge-aware pointer, according to some example embodiments.

FIG. 3-4 are face views of the display screen, illustrating movement and reorientation of the edge-aware pointer, according to some example embodiments.

FIG. 5 is an enlarged face view of the edge-aware pointer, showing its reorientation as depicted in FIG. 1-2, according some example embodiments.

FIG. 6 is an enlarged face view of the edge-aware pointer, showing its reorientation as depicted in FIG. 3-4, according to some example embodiments.

FIG. 7 is an enlarged face view of the edge-aware pointer, illustrating its positional location and its indicative location being offset by a fixed distance, according to some example embodiments.

FIG. 8 is a block diagram illustrating components of a user device suitable for providing an edge-aware pointer, according to some example embodiments.

FIG. 9-12 are flowcharts illustrating operations of the user device in performing a method of providing an edge-aware pointer, according to some example embodiments.

FIG. 13 is a block diagram illustrating components of a machine, according to some example embodiments, able to read instructions from a machine-readable medium and perform any one or more of the methodologies discussed herein.

### DETAILED DESCRIPTION

Example methods and systems are directed to an edge-aware pointer. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine with a display screen may be configured as a user device that provides a user interface (e.g., a graphical user interface) with an edge-aware pointer (e.g., an edge-aware cursor). This pointer may be edge-aware in the sense that the machine may orient or reorient (e.g., from pointing in one direction to pointing in another direction) the pointer based on (e.g., in response to) the pointer being moved (e.g., according to input received from the user of the user device) near one or more edges of the display screen (e.g., moved to a location within a threshold distance from an edge of the display screen).

For example, the user device may have a touch-sensitive display screen (e.g., a touch screen), and a user of the user device may use a fingertip or a stylus to move (e.g., via dragging) the pointer from a first location near the center of the display screen to a second position near the right edge of the display screen. Supposing that the user is right-handed, the user's right hand or one of its fingers may obscure (e.g., block) some or all of the content of the display screen presented to the right of the pointer (e.g., down and to the right of the pointer). This may render it difficult for the user to precisely position the pointer so as to indicate one or more locations obscured by the user's right hand or a finger thereof.

Similarly, supposing that the user is left-handed, the user's left-hand or one of its fingers may obscure some or all of the content of the display screen presented to the left of the pointer (e.g., down and to the left of the pointer). This may make it difficult for the user to precisely position the pointer so as to indicate one or more locations obscured by the user's left hand or a finger thereof.

In addition, the pointer may be an offset pointer that has a positional location separated by fixed distance (e.g., a predetermined number of pixels) from an indicative location to which the pointer is pointing. As used herein, a “positional location” of a pointer is the location (e.g., coordinates) of a single pixel on the display screen that corresponds to the entire pointer (e.g., represents the location of the entire pointer). As used herein, an “indicative location” of a pointer is the location of a single pixel indicated by the pointer on the display screen (e.g., a single pixel to which the pointer is pointing or indicating). The indicative location of an offset pointer may also be called an “offset location.” Similarly, the fixed distance may also be called the “offset distance” of the pointer.

Depending on its orientation, an offset pointer may be unable to indicate a particular location on the display screen, at least without being reoriented. For example, supposing that an offset pointer is oriented to point directly upwards on the display screen, the lowest location that the offset pointer is able to indicate may be no closer to the bottom edge of the display screen than the fixed distance of the offset pointer. That is, when the positional location of the offset pointer is at the bottom edge of the display screen, the indicated location of the offset pointer may be the fixed distance above the bottom edge. Accordingly, locations on the display screen that are less than the fixed distance away from the bottom edge may be impossible to indicate with the offset pointer in its upward pointing orientation.

Accordingly, the machine with the display screen may provide a pointer in the form of an offset pointer that is automatically reoriented (e.g., rotated to a new orientation) based on the pointer being moved near an edge of the display screen. In this manner, the pointer may constitute all or part of an edge-aware pointer that enables a user of the machine to precisely position the pointer to indicate any location on the display screen, regardless of proximity to any edge of the display screen.

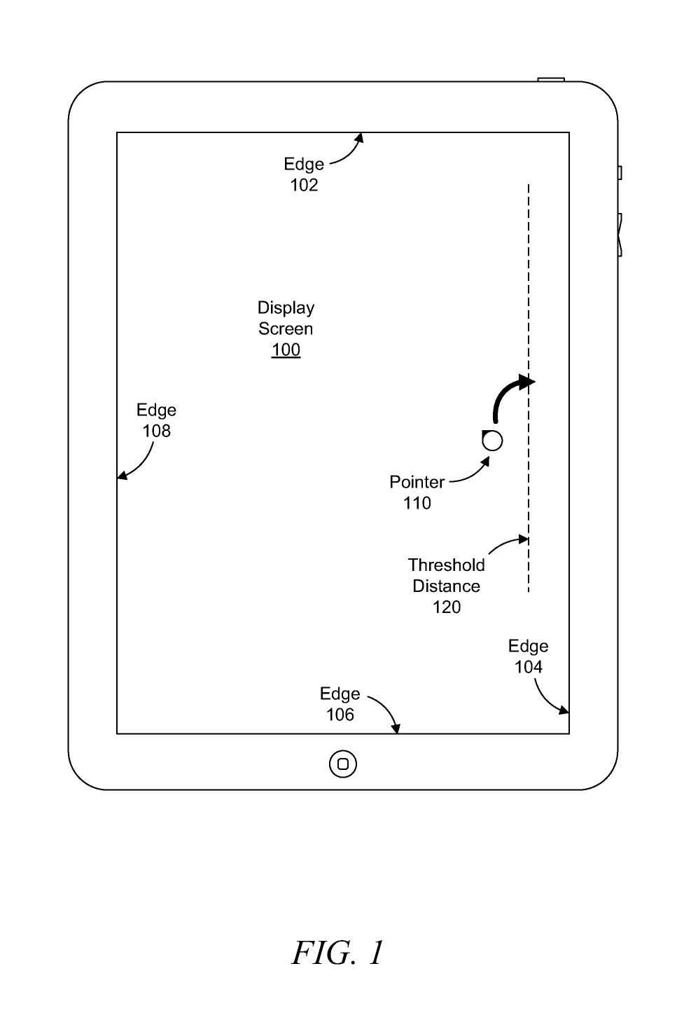

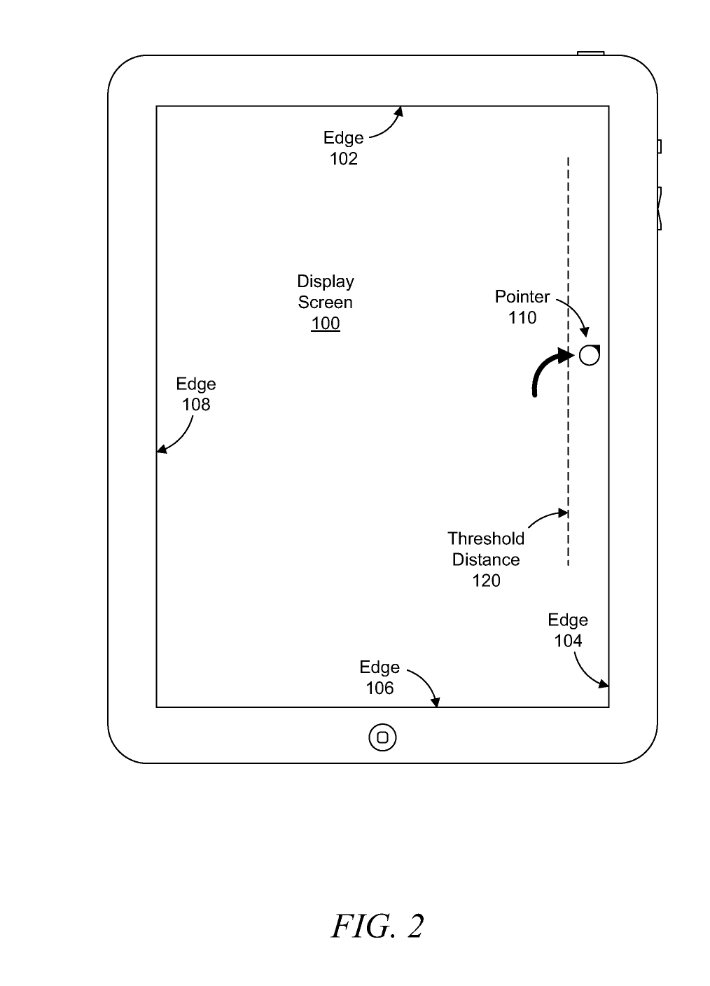

FIG. 1-2 are face views of a display screen 100, illustrating movement and reorientation of a pointer 110, according to some example embodiments. The display screen 100 has multiple edges 102, 104, 106, and 108. As shown, the edge 102 is a top edge (e.g., an upper edge) of the display screen 100; the edge 104 is a right edge of the display screen 100; the edge 106 is a bottom edge (e.g., a lower edge) of the display screen 100; and the edge 108 is a left edge of the display screen 100.

In FIG. 1, the pointer 110 is oriented up and left within the display screen 100. Also, the pointer 110 is presented at a location (e.g., a first location) that is beyond a threshold distance 120 from the edge 104 (e.g., the right edge) of the display screen 100. The threshold distance 120 is shown as a dashed line that represents locations that are at the threshold distance 120 away from the edge 104. According to various example embodiments, the threshold distance 120 may be visibly indicated or invisible on the display screen 100. As indicated by the heavy curved arrow, the pointer 110 may be moved (e.g., by a user) to another location (e.g., a second location) that is within the threshold distance 120 from the edge 104 of the display screen 100.

In FIG. 2, the pointer 110 has been moved to a new location (e.g., the second location) compared to the location shown in FIG. 1. Also, the pointer 110 has been reoriented to point up and right within the display screen 100, instead of up and left. In some example embodiments, the display screen 100 is touch-sensitive, and the pointer 110 is a cursor that is operable by touch with a fingertip of a user. Accordingly, the example embodiments shown in FIG. 1-2 may be suitable for a right-handed user whose right index finger may be used to move the pointer 110 around the display screen 100.

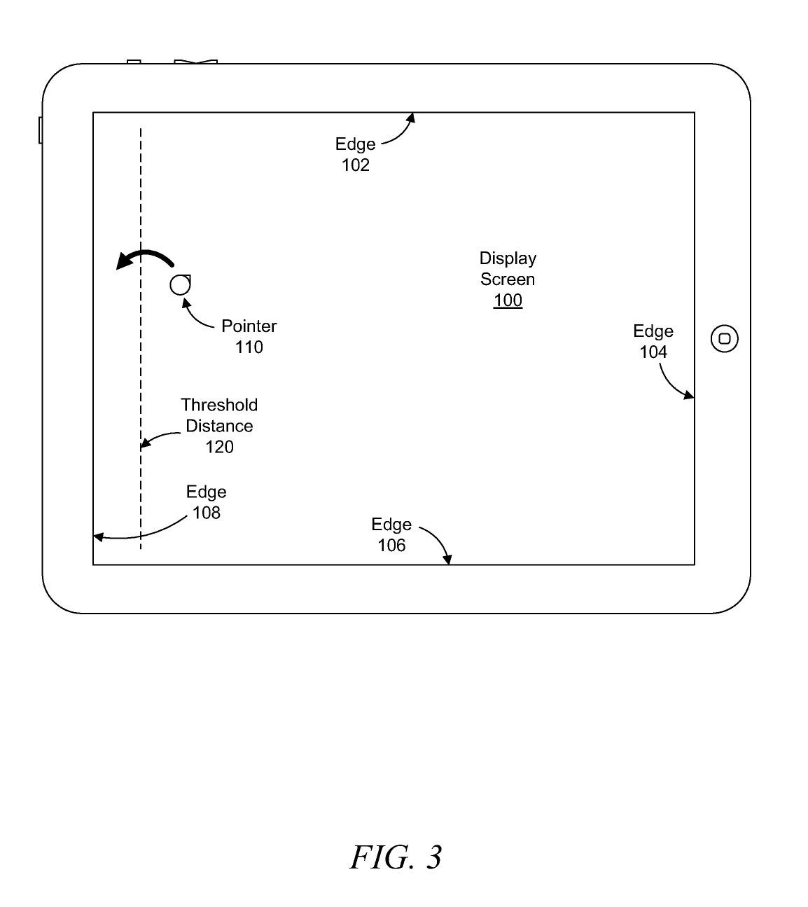

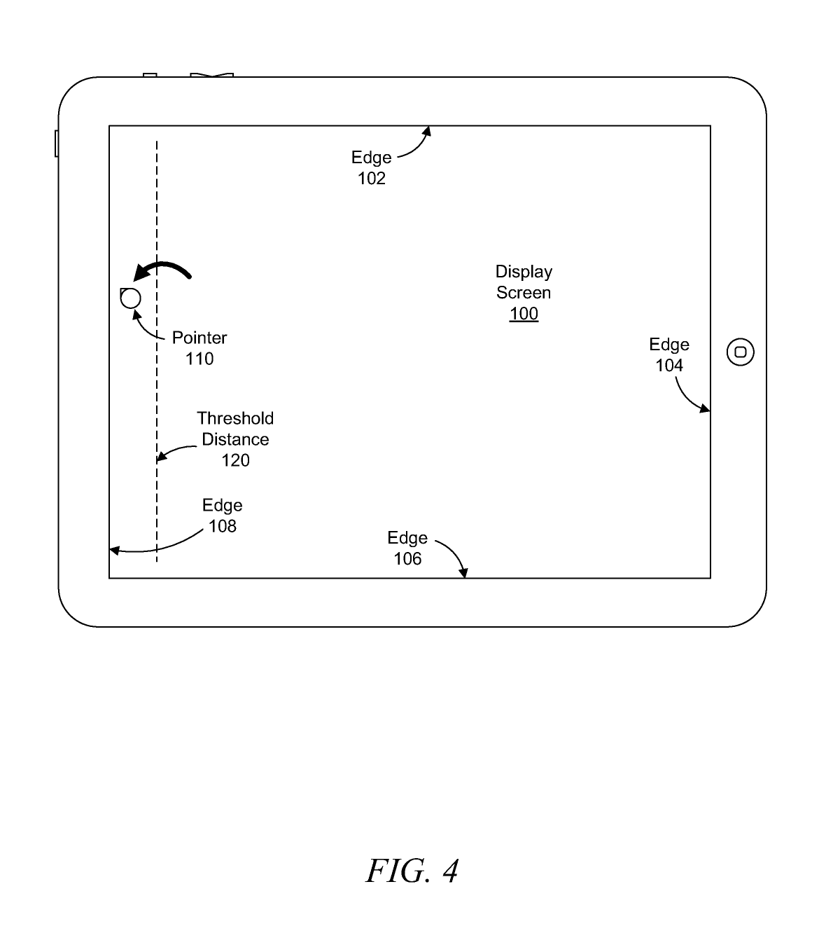

FIG. 3-4 are face views of the display screen, illustrating movement and reorientation of the pointer 110, according to some example embodiments. The display screen 100 has the edges 102, 104, 106, and 108. As shown, the edge 102 is a top edge (e.g., an upper edge) of the display screen 100; the edge 104 is a right edge of the display screen 100; the edge 106 is a bottom edge (e.g., a lower edge) of the display screen 100; and the edge 108 is a left edge of the display screen 100.

In FIG. 3, the pointer 110 is oriented up and right within the display screen 100. Also, the pointer 110 is presented at a location (e.g., a first location) that is beyond a threshold distance 120 from the edge 108 (e.g., the left edge) of the display screen 100. A threshold distance 120 is shown as a dashed line that represents locations that are at the threshold distance 120 away from the edge 108. According to various example embodiments, the threshold distance 120 may be visibly indicated or invisible on the display screen 100. As indicated by the heavy curved arrow, the pointer 110 may be moved (e.g., by a user) to another location (e.g., a second location) that is within the threshold distance 120 from the edge 108 of the display screen 100.

In FIG. 4, the pointer 110 has been moved to a new location (e.g., the second location) compared to the location shown in FIG. 3. Also, the pointer 110 has been reoriented to point up and left within the display screen 100, instead of up and right. In some example embodiments, the display screen 100 is touch-sensitive, and the pointer 110 is a cursor that is operable by touch with a fingertip of the user. Accordingly, the example embodiments shown in FIG. 3-4 may be suitable for a left-handed user whose left index finger may be used to move the pointer 110 around the display screen 100.

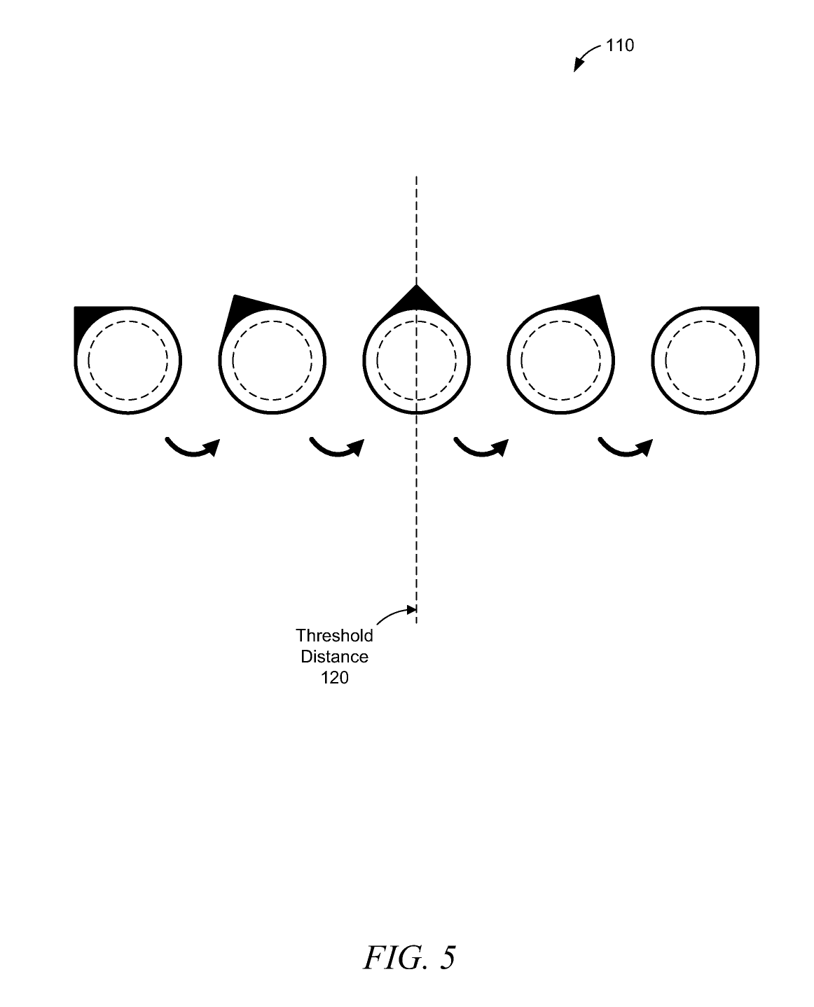

FIG. 5 is an enlarged face view of the pointer 110, showing its reorientation as depicted in FIG. 1-2, according some example embodiments. As discussed above with respect to FIG. 1-2, the pointer 110 is initially oriented up and left within the display screen 100 (e.g., as shown in FIG. 1), and the pointer 110 is then reoriented to point up and right within the display screen 100 (e.g., as shown in FIG. 2).

As indicated by the heavy curved arrows in FIG. 5, the pointer 110 may be reoriented from its initial orientation (e.g., a first orientation) to another orientation (e.g., a second orientation). This reorientation of the pointer 110 may be performed based on (e.g., in response to) the pointer 110 being moved within the threshold distance 120 from the edge 104 of the display screen 100. In FIG. 5, the dashed vertical line represents the threshold distance 120 from the edge 104 of the display screen 100. According to certain example embodiments, the pointer 110 may be reoriented as it transgresses (e.g., crosses) a line (e.g., visible or invisible within the display screen 100) representing the threshold distance 120 from the edge 104 of the display screen 100.

Five instances of the pointer 110 are shown in FIG. 5 as representing the orientations of the pointer 110 at five different points in time. As shown, the pointer 110 begins pointing up and left, before rotating (e.g., 22.5 degrees clockwise) to a mostly upward and slightly left pointing orientation, before rotating (e.g., 22.5 degrees further clockwise) to a fully upward pointing orientation, before rotating (e.g., 22.5 degrees further clockwise) to a mostly upward and slightly right pointing orientation, before rotating (e.g., 22.5 degrees further clockwise) to point up and right, with respect to the display screen 100.

Within each of the five instances of the pointer 110 shown in FIG. 5, a dashed interior circle represents a contact patch that corresponds to a fingertip, knuckle, or stylus of a user making contact with the display screen 100 (e.g., a touch-screen). For example, a fingertip in contact with the display screen 100 may contact the display screen 100 in a circular contact patch. According to various example embodiments, the interior circle (e.g., dashed, solid, or otherwise) may be visibly indicated or invisible on the display screen 100.

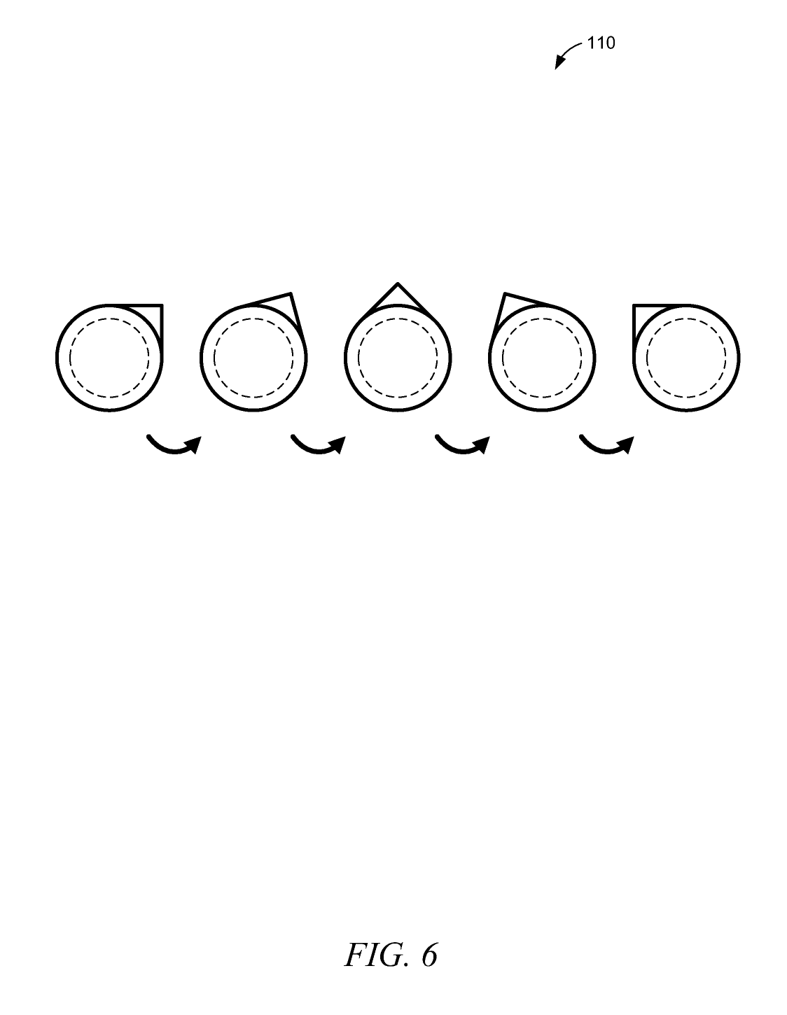

FIG. 6 is an enlarged face view of the pointer 110, showing its reorientation as depicted in FIG. 3-4, according to some example embodiments. As discussed above with respect to FIG. 3-4, the pointer 110 is initially oriented up and right within the display screen 100 (e.g., as shown in FIG. 3), and the pointer 110 is then reoriented to point up and left within the display screen 100 (e.g., as shown in FIG. 4).

As indicated by the heavy curved arrows in FIG. 6, the pointer 110 may be reoriented from its initial orientation (e.g., a first orientation) to another orientation (e.g., a second orientation). This reorientation of the pointer 110 may be performed based on (e.g., in response to) the pointer 110 being moved within the threshold distance 120 from the edge 108 of the display screen 100. According to certain example embodiments, the pointer 110 may be reoriented as it transgresses (e.g., crosses) a line (e.g., visible or invisible within the display screen 100) representing the threshold distance 120 from the edge 108 of the display screen 100.

Five instances of the pointer 110 are shown in FIG. 6 as representing the orientations of the pointer 110 at five different points in time. As shown, the pointer 110 begins pointing up and right, before rotating (e.g., 22.5 degrees counterclockwise) to a mostly upward and slightly right pointing orientation, before rotating (e.g., 22.5 degrees further counterclockwise) to a fully upward pointing orientation, before rotating (e.g., 22.5 degrees further counterclockwise) to a mostly upward and slightly left pointing orientation, before rotating (e.g., 22.5 degrees further counterclockwise) to point up and left, with respect to the display screen 100.

Within each of the five instances of the pointer 110 shown in FIG. 6, a dashed interior circle represents a contact patch that corresponds to a fingertip, knuckle, or stylus of a user making contact with the display screen 100 (e.g., a touch-screen). According to various example embodiments, the interior circle (e.g., dashed, solid, or otherwise) may be visibly indicated or invisible on the display screen 100.

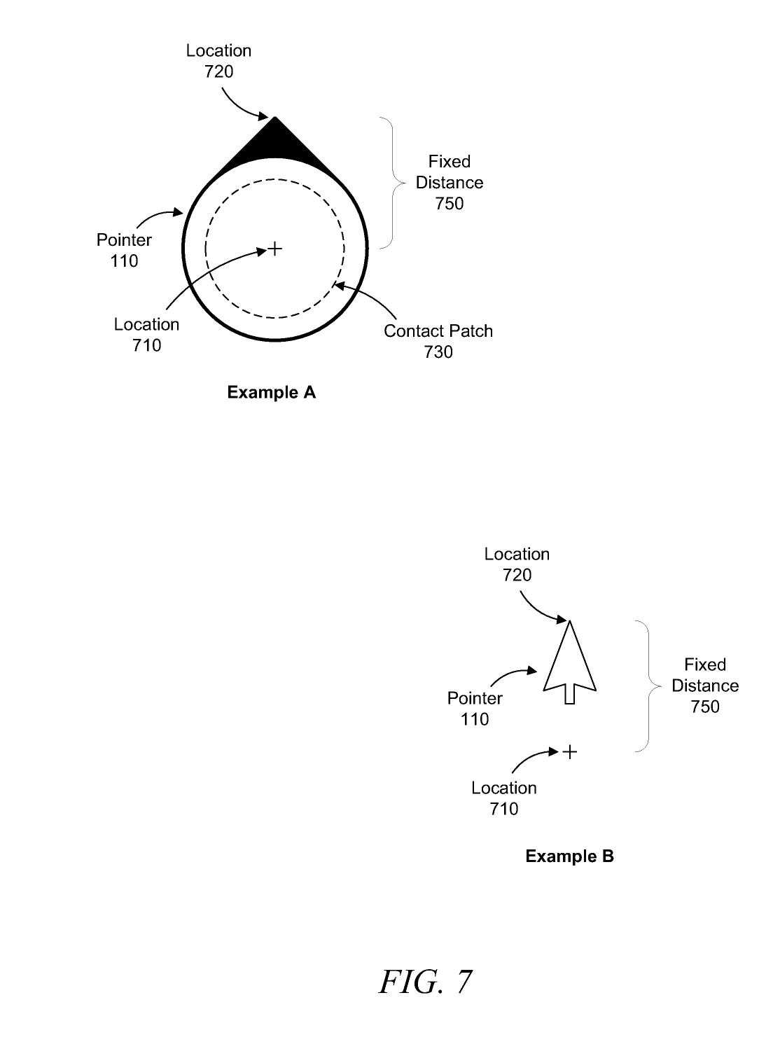

FIG. 7 is an enlarged face view of the pointer 110, in the form of an offset pointer, illustrating a location 710 for its position being offset by a fixed distance 750 away from a location 720 indicated by the pointer 110, according to some example embodiments. The location 710 may be the positional location of the pointer 110, and the location 720 may be the indicative location (e.g., offset location) of the pointer 110. FIG. 7 shows two example embodiments of the pointer 110. These example embodiments are labeled “Example A” and “Example B.” In both example embodiments shown, the location 710 is marked by a small crosshair. This crosshair may be visibly indicated or invisible within the display screen 100. In “Example A,” a dashed interior circle represents a contact patch 730 that corresponds to a fingertip, knuckle, or stylus of a user making contact with the display screen 100 (e.g., a touch-screen). According to various example embodiments, the interior circle (e.g., dashed, solid, or otherwise) may be visibly indicated or invisible on the display screen 100.

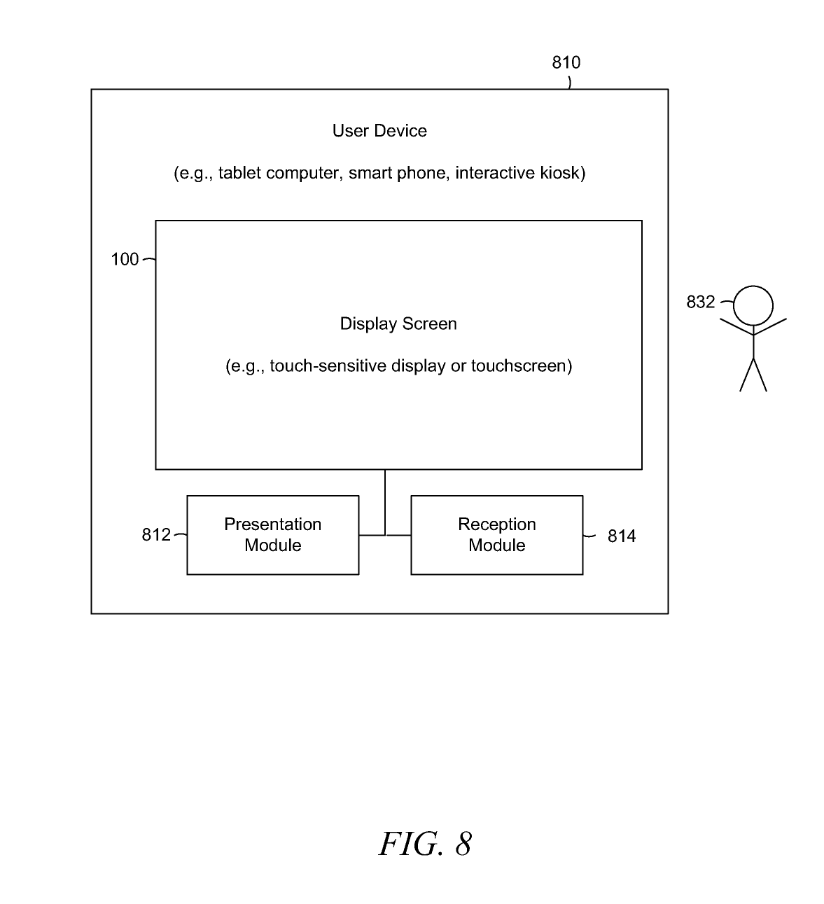

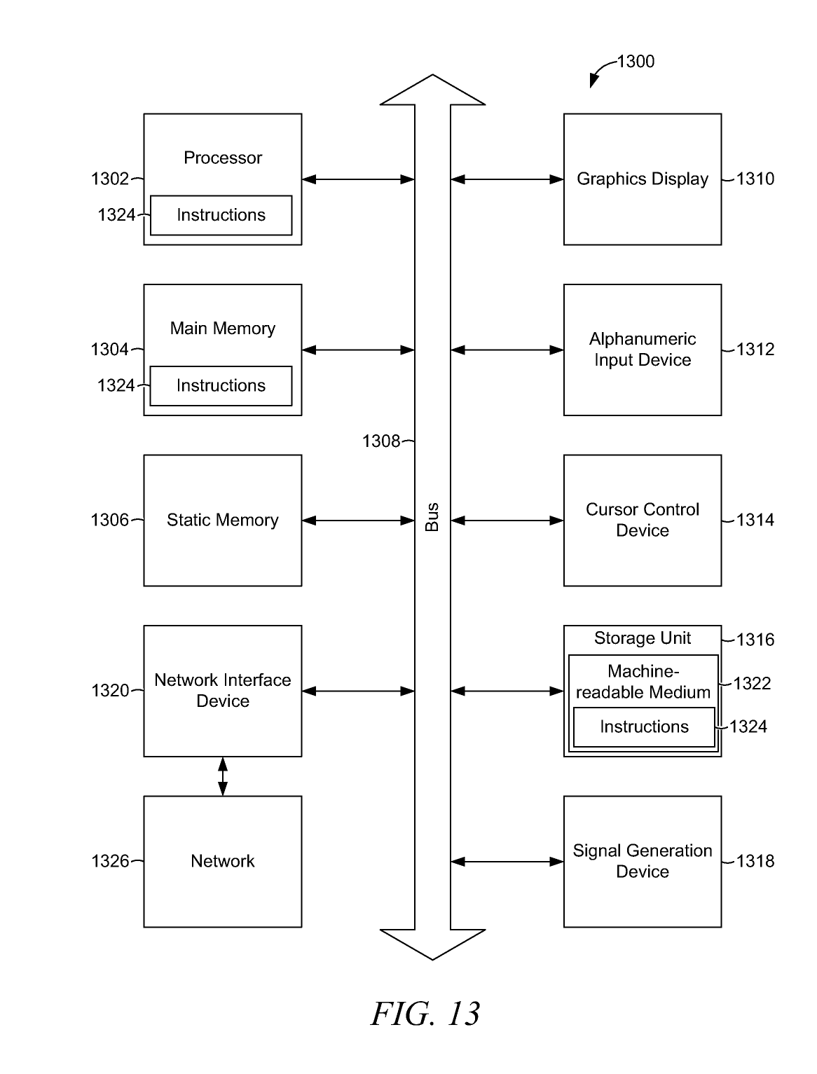

FIG. 8 is a block diagram illustrating components of a user device 810 suitable for providing (e.g., presenting) the pointer 110, according to some example embodiments. The user device 810 is a machine (e.g., a tablet computer, a smartphone, an interactive kiosk, or any suitable combination thereof, that may be used by a user 832. The user device 810 may be implemented in a computer system, in whole or in part, as described below with respect to FIG. 13. Accordingly, the user device 810 may be implemented in a general-purpose computer modified (e.g., configured or programmed) by software to be a special-purpose computer to perform the functions described herein for the user device 810.

The user 832 may be a human user (e.g., a human being), a machine user (e.g., a computer configured by a software program to interact with the user device 810), or any suitable combination thereof (e.g., a human assisted by a machine or a machine supervised by a human). The user 832 is not part of the user device 810, but is associated with the user device 810, and may be the owner of the user device 810. For example, the device 810 may be a desktop computer, a vehicle computer, a tablet computer, a navigational device, a portable media device, or a smart phone belonging to the user 832.

As shown in FIG. 8, the user device 810 includes the display screen 100, which is discussed above, a presentation module 812, and a reception module 814, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Likewise, the display screen 100 may be implemented using hardware (e.g., an electronic display, an optical display, a projector, a heads-up display, a pair of stereoscopic goggles, or any suitable combination thereof) or a combination of hardware and software. Furthermore, the display screen 100 may be combined with any one or more of the modules of the user device 810, and the functions described herein for the display screen 100 may be subdivided among multiple modules (e.g., a graphics sub-module and a control sub-module).

The presentation module 812 is configured to present the pointer 110 on the display screen 100. In particular, the presentation module 812 may present the pointer 110 with a first orientation and at a first location on the display screen 100. As noted above, the first location may be beyond the threshold distance 120 from an edge (e.g., a first edge) of the display screen 100 (e.g., edge 104 or edge 108).

The presentation module 812 may further be configured to present the pointer 110 with a second orientation and at a second location on the display screen 100. As noted above, the second location may be within the threshold distance 120 from the edge (e.g., the first edge) of the display screen 100. Moreover, the presenting of the pointer 110 with the second orientation may be performed in response to a user-generated command (e.g., that the pointer 110 be presented at the second location). Furthermore, the presenting of the pointer 110 with the second orientation may be based on (e.g., in response to, triggered by, or initiated by) the second location being within the threshold distance 120 from the edge of the display screen 100.

The reception module 814 is configured to receive the user-generated command. In some example embodiments, the reception module 840 receives the user-generated command in the form of a touch command (e.g., a single tap, a double tap, a triple tap, a drag, or any suitable combination thereof) directed to the pointer 110, which may be presented on the display screen 100. In certain example embodiments, the user generated command is a gesture command (e.g., one or more motions made in three-dimensional space). According to various example embodiments, the user-generated command may be generated by the user 832 using a finger of the user, a hand of the user, a stylus, a pen, a marker, a brush, a wand, a remote control device, or any suitable combination thereof. Further details of the user device 810 and its modules are discussed below.

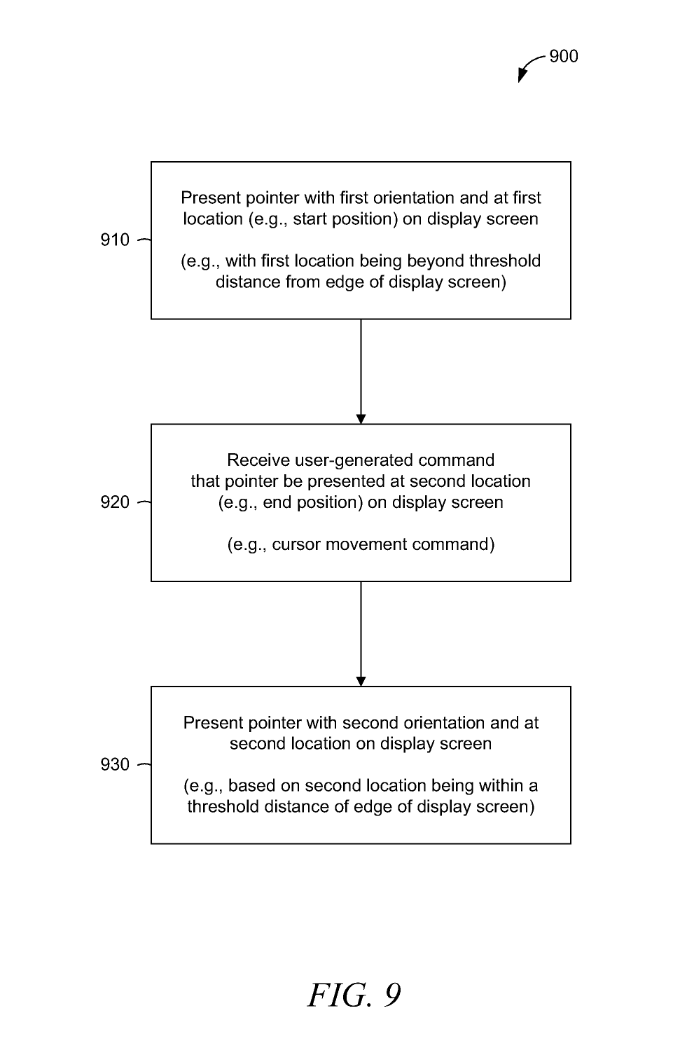

FIG. 9-12 are flowcharts illustrating operations of the user device 810 in performing a method 900 of providing the pointer 110, according some example embodiments. Operations in a method 900 may be performed by the user device 810, using modules described above with respect to FIG. 8. As shown in FIG. 9, the method 900 includes operations 910, 920, and 930.

In operation 910, the presentation module 812 presents the pointer 110 on the display screen 100. As noted above, the display screen 100 may have multiple edges (e.g., edges 102, 104, 106, and 108). A particular edge among the multiple edges may be designated (e.g., by a configuration parameter for the user device 810, a user preference of the user 832, or any suitable combination thereof), or as the edge (e.g., the first edge) from which the threshold distance 120 is determined (e.g., measured or referenced).

Moreover, in operation 910, the presentation module 812 presents the pointer 110 with a first orientation (e.g., pointing up and to the right, or pointing up and to the left) and at a first location (e.g., a first positional location of the pointer 110) within the display screen 100. This may have the effect of presenting (e.g., displaying) the pointer 110 at an initial position (e.g., start position, as indicated by a finger in contact with the display screen 100) on the display screen 100. In particular, this first location (e.g., initial position) may be beyond the threshold distance 120 from the first edge of the display screen 100. In some example embodiments, the first orientation is a default orientation, an initial orientation, a start orientation, or any suitable combination thereof.

In operation 920, the reception module 814 receives a user-generated command (e.g., a gesture command, a touch command, or any suitable combination thereof) that the pointer 110 be presented at a second location (e.g., a second positional location of the pointer 110) on the display screen 100. That is, the received user-generated command may be a command to move the pointer 110 to a subsequent position (e.g., an end position, as indicated by the finger in contact with the display screen 100) on the display screen 100. In particular, this second location (e.g., subsequent position) may be within the threshold distance 120 from the first edge of the display screen 100.

In operation 930, the presentation module 812 presents the pointer 110 with a second orientation (e.g., a new orientation rotated 90 degrees clockwise or counterclockwise from the first orientation) and at the second location. As noted above, the second location may be within the threshold distance 120 from the first edge of the display screen 100. In some example embodiments, the second orientation is an alternative orientation, a subsequent orientation, an end orientation, or any suitable combination thereof.

Furthermore, in operation 930, the presenting of the pointer 110 with the second orientation may be based on (e.g., in response to) the user-generated command received in operation 920. In addition, operation 930 may be performed based on the second location being within the threshold distance 120 from the first edge of the display screen 100.

In some example embodiments, the presentation module 820 performs operation 930 by reorienting (e.g., rotating) the pointer 110 in the visible matter on the display screen 100. This may have the effect of allowing the user 832 to see how the location 720 (e.g., the indicative location) of the pointer 110 moves with respect to the location 710 (e.g., the positional location) of the pointer 110. Moreover, the reorienting of the pointer 110 may be performed as the pointer 110 transgresses a line (e.g., visible or not) that represents the threshold distance 120 from the first edge of the display screen 100. This may have the effect of indicating to the user 832 that locations on the display screen 100 that are within the threshold distance 120 from the first edge are to be indicated with an alternative orientation (e.g., the second orientation) for the pointer 110.

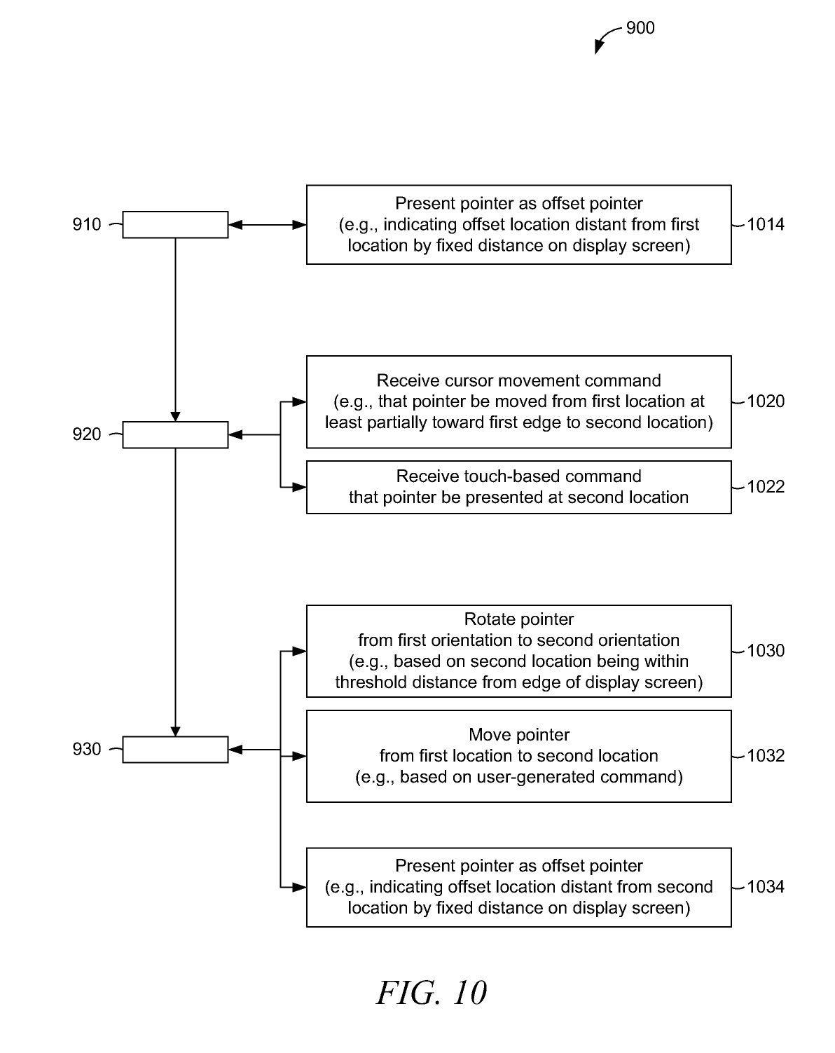

As shown in FIG. 10, the method 900 may include one or more of operations 1014, 1020, 1022, 1030, 1032, and 1034. In some example embodiments, the pointer 110 is an offset pointer, as described above with respect to FIG. 7, and the method 900 may include operations 1014 and 1034.

Operation 1014 may be performed as part (e.g., a precursor task, a subroutine, or a portion) of operation 910, in which the presentation module 812 presents the pointer 110 with the first orientation. In operation 1014, the presentation module 812 presents the pointer 110 as an offset pointer. As noted above, the offset pointer may indicate the location 720 (e.g., as the indicative location or offset location of the pointer 110). Accordingly, the location 710 (e.g., the positional location) of the pointer 110 may be at the first location during operation 910, and the location 720 (e.g., the offset location) of the pointer 110 may be distant from the first location by a fixed distance (e.g., a predetermined number of pixels) on the display screen 100.

Operation 1034 may be performed as part (e.g., a precursor task, a subroutine, or a portion) of operation 930, in which the presentation module 812 presents the pointer 110 with the second orientation. In operation 1034, the presentation module 812 presents the pointer 110 as the offset pointer discussed above with respect to operation 1014. Accordingly, the location 710 (e.g., the positional location) of the pointer 110 may be at the second location during operation 930, and the location 720 (e.g., the offset location) of the pointer 110 may be distant from the second location by the fixed distance (e.g., the predetermined number of pixels) on the display screen 100.

In certain example embodiments, one or more of operations 1020 and 1022 may be performed as part (e.g., a precursor task, a subroutine, or a portion) of operation 920, in which the reception module 814 receives the user-generated command. In operation 1020, the reception module 814 receives a cursor movement command. The cursor movement command may be a command that the pointer 110 be moved from the first location (e.g., initial location) at least partially toward the first edge of the display screen 100, a command that the pointer 110 be moved to the second location (e.g., subsequent location) within the display screen 100, or any suitable combination thereof. For example, the cursor movement command may specify that the pointer 110 be moved along any trajectory of any length within the display screen 100, and any one or more components (e.g., vector component) of this trajectory may move the pointer 110 toward the first edge of the display screen 100. Accordingly, the trajectory of the pointer 110 may cause the pointer 110 to be presented at the second location that is within the threshold distance 120 from the first edge of the display screen 100.

In operation 1022, the reception module 814 receives a touch-based command (e.g., as an example of a gesture command) that the pointer 110 be presented at the second location (e.g., the subsequent location) within the display screen 100. As noted above, the display screen 100 may be sensitive to touch (e.g., a touch screen). Accordingly, operation 1022 may be performed by receiving the touch-based command from the display screen 100.

One or more of operations 1030 and 1032 may be performed as part (e.g., a precursor task, a subroutine, or a portion) of operation 930, in which the presentation module 812 presents the pointer 110 with the second orientation. In operation 1030, the presentation module 812 reorients (e.g., rotates) the pointer 110 on the display screen 100 from the first orientation (e.g., start orientation) to the second orientation (e.g., subsequent orientation). Accordingly, the presentation module 812 may present the pointer 110 with the second orientation by rotating the pointer 110 from the first orientation to the second orientation. Moreover, operation 1030 may be performed based on the second location being within the threshold distance 120 of the first edge of the display screen 100.

In operation 1032, the presentation module 812 moves the pointer 110 on the display screen 100 from the first location (e.g., an initial positional location of the pointer 110) to the second location (e.g., a subsequent positional location of the pointer 110. Movement of the pointer 110 may be performed by translating the pointer 110 across all or part of the display screen 100. According, the presentation module 812 may present the pointer 110 with the second orientation by moving the pointer 110 from the first location to the second location. Furthermore, operation 1032 may be performed based on the user-generated command received in operation 920.

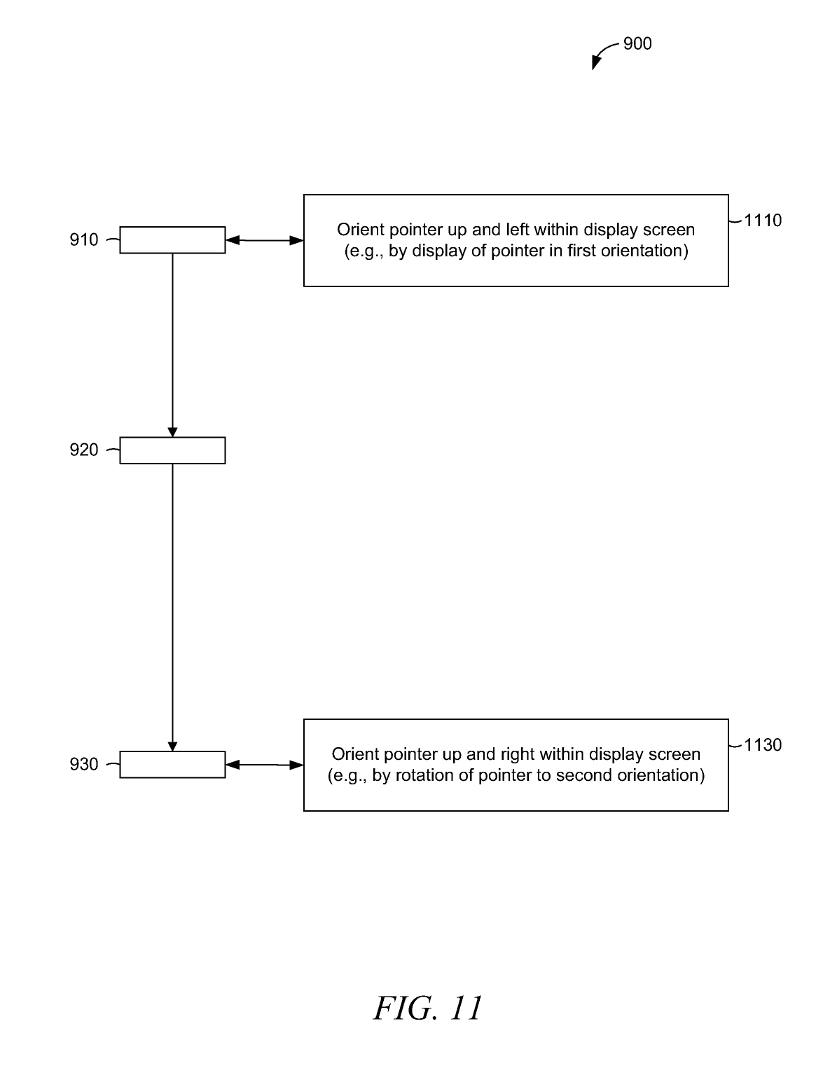

As shown in FIG. 11, the method 900 may include operations 1110 and 1130. In some example embodiments, the pointer 110 is reoriented from a first orientation that points up and left within the display screen 100 to a second orientation that points up and right within the display screen 100. Accordingly, operation 1110 may be performed as part (e.g., a precursor task, a subroutine, or a portion) of operation 910, in which the presentation module 812 presents the pointer 110 with the first orientation and at the first location on the display screen 100. In operation 1110, the presentation module 812 orients (e.g., points or rotates) the pointer 110 up and left within the display screen 100 (e.g., as discussed above with respect to FIG. 5).

Similarly, operation 1130 may be performed as part of operation 930, in which the presentation module 812 presents the pointer 110 with the second orientation and at the second location on the display screen 100. In operation 1130, the presentation module 812 orients (e.g., reorients, points, or rotates) the pointer 110 up and right within the display screen 100 (e.g., as discussed above with respect to FIG. 5). Operation 1130 may be performed based on (e.g., in response to) the second location being within the threshold distance 120 from the edge 104 of the display screen 100. In some example embodiments, operation 1130 is performed as the pointer 110 crosses a line (e.g., visible or invisible) representing the threshold distance 120 from the edge 104 of the display screen 100.

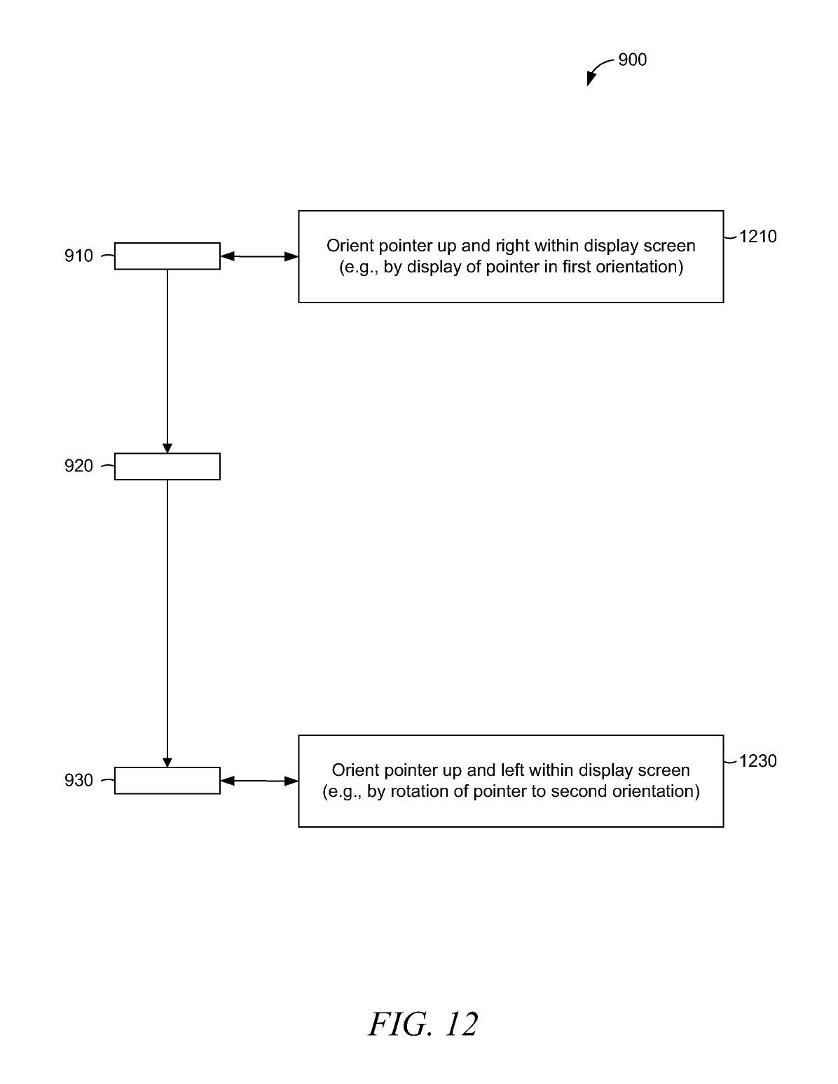

As shown in FIG. 12, the method 900 may include operations 1210 and 1230. In certain example embodiments, the pointer 110 is reelected from a first orientation that points up and right within the display screen 100 to a second orientation that points up and left within the display screen 100. Accordingly, operation 1210 may be performed as part (e.g., a precursor task, a subroutine, or a portion) of operation 910, in which the presentation module 812 presents the pointer 110 with the first orientation and at the first location on the display screen 100. In operation 1210, the presentation module 812 orients the pointer 110 up and right within the display screen 100 (e.g., as discussed above with respect to FIG. 6).

Likewise, operation 1230 may be performed as part of operation 930, in which the presentation module 812 presents the pointer 110 with the second orientation and at the second location on the display screen 100. In operation 1230, the presentation module 812 orients the pointer 110 up and left within the display screen 100 (e.g., as discussed above with respect to FIG. 6). Operation 1230 may be performed based on the second location being within the threshold distance 120 from the edge 108 of the display screen 100. In some example embodiments, operation 1230 is performed as the pointer 110 crosses a line (e.g., visible or invisible) representing the threshold distance 120 from the edge 108 of the display screen 100.

Although the above discussion focuses on the pointer 110 being reoriented from the first orientation to the second orientation, based on the pointer 110 being moved within the threshold distance 120 from an edge of the display 100, the systems and methods discussed herein also contemplate a subsequent reorientation of the pointer 110 from the second orientation back to the first orientation, based on the pointer 110 being moved beyond the threshold distance 120 from the edge. In some example embodiments, as though the user 832 moves the pointer 110 away from the edge (e.g., the first edge), the user device 810 rotates the pointer back to the first orientation (e.g., its default orientation or its initial orientation).

According to various example embodiments, one or more of the methodologies described herein may facilitate provision, presentation, or usage of an edge-aware pointer (e.g., pointer 110). Moreover, one or more of the methodologies described herein may facilitate enhanced precision in moving the edge-aware pointer to one or more locations on a display screen (e.g., display screen 100). Hence, one or more the methodologies described herein may facilitate enhanced precision in indicating a location (e.g., an indicative location, such as location 720) on a display screen.

When these effects are considered in aggregate, one or more of the methodologies described herein may obviate a need for certain efforts or resources that otherwise would be involved in precisely moving a pointer around a display screen and precisely indicating a location on the display screen. Efforts expended by a user in precisely performing cursor manipulation may be reduced by one or more of the methodologies described herein. Computing resources used by one or more machines or devices (e.g., user device 810) may similarly be reduced. Examples of such computing resources include processor cycles, memory usage, data storage capacity, power consumption, and cooling capacity.

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system and within which instructions 1324 (e.g., software) for causing the machine 1300 to perform any one or more of the methodologies discussed herein may be executed. In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a peer-to-peer (or distributed) network environment. The machine 1300 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1324, sequentially or otherwise, that specify actions to be taken by that machine. Further, while only a single machine is illustrated, the term “machine” shall also be taken to include a collection of machines that individually or jointly execute the instructions 1324 to perform any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The machine 1300 may further include a graphics display 1310 (e.g., a plasma display panel (PDP), a light emitting diode (LED) display, a liquid crystal display (LCD), a projector, or a cathode ray tube (CRT)). The machine 1300 may also include an alphanumeric input device 1312 (e.g., a keyboard), a cursor control device 1314 (e.g., a mouse, a touchpad, a trackball, a joystick, a motion sensor, or other pointing instrument), a storage unit 1316, a signal generation device 1318 (e.g., a speaker), and a network interface device 1320.

The storage unit 1316 includes a machine-readable medium 1322 on which is stored the instructions 1324 (e.g., software) embodying any one or more of the methodologies or functions described herein. The instructions 1324 may also reside, completely or at least partially, within the main memory 1304, within the processor 1302 (e.g., within the processor's cache memory), or both, during execution thereof by the machine 1300. Accordingly, the main memory 1304 and the processor 1302 may be considered as machine-readable media. The instructions 1324 may be transmitted or received over a network 1326 via the network interface device 1320.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1300), such that the instructions, when executed by one or more processors of the machine (e.g., processor 1302), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or in a “software as a service” (SaaS) environment. For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
presenting a pointer on a display screen that has a first edge among multiple edges of the display screen,
the pointer being presented with a first orientation on the display screen and at a first location that is beyond a threshold distance from the first edge of the display screen;
receiving a user-generated command that the pointer be presented at a second location that is within the threshold distance from the first edge of the display screen; and
presenting the pointer with a second orientation on the display screen and at the second location that is within the threshold distance from the first edge of the display screen,
the presenting of the pointer with the second orientation being performed by a processor of a machine in response to the received user-generated command and based on the second location being within the threshold distance from the first edge of the display screen.

2. The method of claim 1, wherein:
the receiving of the user-generated command includes receiving a cursor movement command that the pointer be moved from the first location at least partially toward the first edge to the second location within the display screen.

3. The method of claim 1, wherein:
the presenting of the pointer with the second orientation at the second location includes rotating the pointer on the display screen from the first orientation to the second orientation;
the rotating of the pointer being based on the second location being within the threshold distance of the first edge of the display screen.

4. The method of claim 1, wherein:
the presenting of the pointer with the second orientation at the second location includes moving the pointer on the display screen from the first location to the second location.

5. The method of claim 1, wherein:
the display screen is touch sensitive; and
the receiving of the user-generated command includes receiving a touch-based command that the pointer be presented at the second location that is within the threshold distance from the first edge of the display screen.

6. The method of claim 1, wherein:
the multiple edges of the display screen include a right edge, a left edge, a top edge, and a bottom edge;
the first edge of the display screen is the right edge of the display screen.

7. The method of claim 6, wherein:
the presenting of the pointer with the first orientation at the first location includes orienting the pointer up and left within the display screen.

8. The method of claim 6, wherein:
the presenting of the pointer with the second orientation at the second location includes orienting the pointer up and right within the display screen.

9. The method of claim 1, wherein:
the multiple edges of the display screen include a right edge, a left edge, a top edge, and a bottom edge;
the first edge of the display screen is the left edge of the display screen.

10. The method of claim 9, wherein:
the presenting of the pointer with the first orientation at the first location includes orienting the pointer up and right within the display screen.

11. The method of claim 9, wherein:
the presenting of the pointer with the second orientation at the second location includes orienting the pointer up and left within the display screen.

12. The method of claim 1, wherein:
the first location represents a start position indicated by a finger in contact with the display screen;
the second location represents an end position indicated by the finger in contact with the display screen.

13. The method of claim 1, wherein:
the presenting of the pointer with the first orientation at the first location includes presenting the pointer as an offset pointer that indicates an offset location distant from the first location by a predetermined number of pixels on the display screen.

14. The method of claim 1, wherein:
the presenting of the pointer with the second orientation at the second location includes presenting the pointer as an offset pointer that indicates an offset location distant from the second location by a predetermined number of pixels on the display screen.

15. A non-transitory machine-readable storage medium comprising instructions that, when executed by one or more processors of a machine, cause the machine to perform operations comprising:
presenting a pointer on a display screen that has a first edge among multiple edges of the display screen,
the pointer being presented with a first orientation on the display screen and at a first location that is beyond a threshold distance from the first edge of the display screen;
receiving a user-generated command that the pointer be presented at a second location that is within the threshold distance from the first edge of the display screen; and
presenting the pointer with a second orientation on the display screen and at the second location that is within the threshold distance from the first edge of the display screen,
the presenting of the pointer with the second orientation being performed by a processor of a machine in response to the received user-generated command and based on the second location being within the threshold distance from the first edge of the display screen.

16. The non-transitory machine-readable storage medium of claim 15, wherein:
the receiving of the user-generated command includes receiving a cursor movement command that the pointer be moved from the first location at least partially toward the first edge to the second location within the display screen.

17. The non-transitory machine-readable storage medium of claim 15, wherein:
the presenting of the pointer with the second orientation at the second location includes rotating the pointer on the display screen from the first orientation to the second orientation;
the rotating of the pointer being based on the second location being within the threshold distance of the first edge of the display screen.

18. A system comprising:
a processor configured by a presentation module that configures the processor to present a pointer on a display screen that has a first edge among multiple edges of the display screen,
the pointer being presented with a first orientation on the display screen and at a first location that is beyond a threshold distance from the first edge of the display screen; and
a reception module configured to receive a user-generated command that the pointer be presented at a second location that is within the threshold distance from the first edge of the display screen;
the processor being configured by the presentation module to present the pointer with a second orientation on the display screen and at the second location that is within the threshold distance from the first edge of the display screen,
the presenting of the pointer with the second orientation being performed in response to the received user-generated command and based on the second location being within the threshold distance from the first edge of the display screen.

19. The system of claim 18, wherein:
the reception module is configured to receive the user-generated command by receiving a cursor movement command that the pointer be moved from the first location at least partially toward the first edge to the second location within the display screen.

20. The system of claim 18, wherein:
the processor is configured to present the pointer with the second orientation at the second location by rotating the pointer on the display screen from the first orientation to the second orientation;
the rotating of the pointer being based on the second location being within the threshold distance of the first edge of the display screen.
